(19) United States
(12) Patent Application Publication
(10) Pub. No.: US 2007/0101131 A1
(43) Pub. Date: May 3, 2007

(54) Trusted store tamper detection

(75) Inventors: Ivan D. Davtchev, Seattle, WA (US); Karan S. Dhillon, Renton, WA (US); Nir Ben Zvi, Redmond, WA (US); Aaron Goldsmid, Seattle, WA (US); Ping Xie, Bellevue, WA (US); Yifat Sagiv, Redmond, WA (US)

Correspondence Address: WOODCOCK WASHBURN LLP (MICROSOFT CORPORATION), CIRA CENTRE, 12TH FLOOR, 2929 ARCH STREET, PHILADELPHIA, PA, 19104-2891, US

(73) Assignee: Microsoft Corporation, Redmond, WA (US)

(21) Appl. No.: 11/265,265

(22) Filed: Nov. 1, 2005

(51) Int. Cl. H04L 9/00

(52) U.S. Cl. 713/166

(57) ABSTRACT

A security flag stored in a trusted store is utilized to determine if the trusted store has been subjected to tampering. The security flag is indicative of a globally unique identifier (GUID), the version of the trusted store, and a counter. The security flag is created when the trusted store is created. Each time a critical event occurs, the security flag is updated to indicate the occurrence thereof. The security flag also is stored in a write-once portion of the system registry. At appropriate times, the security flag stored in the trusted store is compared with the corresponding security flag stored in the write-once registry. If the security flags match within a predetermined tolerance, it is determined that the trusted store has not been subjected to tampering. If the security flags do not match, or if a security flag is missing, it is determined that the trusted store has been subjected to tampering.

### TECHNICAL FIELD

The technical field relates generally to secure storage of information, and more specifically to detecting attempts to tamper a trusted store.

### BACKGROUND

A trusted store is a storage location in which contents stored therein are secure or protected. In computing systems for example, a trusted store can be a portion of memory located in a computer. Security is typically provided by encrypting the information stored in the trusted store and/or obfuscating the location of the trusted store. It is not uncommon for licensed applications to utilize a trusted store to prevent tampering of license conditions, such as licensed operation systems, for example. Or in another example, a user can download a free trial offer of song from a network under the condition that the user will be able to listen to the song for a limited amount of time (e.g., 24 hours) without purchasing the song. The conditions limiting the user's use of the song to 24 hours are stored in a trusted store. The intent is to prevent the user, or any unauthorized person, from tampering with the conditions and thus obtaining unlimited use of the song.

A common tactic for compromising a trusted store is to replace files in the trusted store with old versions of the same files or with files from another system. Thus, in the above example, the user could simply download as many songs as desired and copy the trusted store during each download. The user could then load the original version of the trusted store each time the user wants to play a song. The system would be fooled into thinking that the 24 hour grace period is just beginning. This tactic defeats the purpose of the trusted store.

### SUMMARY

A trusted store comprises a security flag that can be verified to provide an indication of tampering of the trusted store. A security flag is indicative of the creation of the security flag and of the version of the trusted store. A security flag is created when the trusted store is created. A security flag also can be created by components writing to the trusted store. Each time a critical event occurs, the appropriate security flag is updated to indicate the occurrence thereof. Security flags also are stored in another portion of memory. At appropriate times, the security flag stored in the trusted store is compared with the corresponding security flag stored in the other portion of memory. If the security flags match (within a predetermined tolerance), it is determined that the trusted store has not been tampered with. If the security flags do not match, it is determined that the trusted store has been tampered with. If a security flag is missing from either the trusted store or the other portion of memory, it is determined that the trusted store has been tampered with.

### BRIEF DESCRIPTION OF THE DRAWINGS

The following description is better understood when read in conjunction with the appended drawings. For purposes of illustrating means for determining if a trusted store has been subjected to tampering, there are shown in the drawings exemplary constructions thereof; however, means for determining if a trusted store has been subjected to tampering is not limited to the specific methods and instrumentalities disclosed. In the drawings:

FIG. 1 is an exemplary diagram of a trusted store and a registry comprising a security flag;

FIG. 2 is a diagram of an exemplary security flag;

FIG. 3 is a flow diagram of an exemplary process for creating a security flag;

FIG. 4 is a flow diagram of an exemplary process for determining if a trusted store has been subjected to tampering; and

FIG. 5 is an illustration of an example of a suitable computing system environment on which means for determining if a trusted store has been subjected to tampering can be implemented.

### DETAILED DESCRIPTION OF ILLUSTRATIVE EMBODIMENTS

A security flag is stored in trusted store to aid in determining if the trusted store has been subjected to tampering. The security flag comprises a globally unique identifier (GUID) that is created when the security flag is created. The GUID uniquely identifies the system in which the security flag is being utilized. The security flag also comprises an indication of the version of the trusted store. This can be in the form of any appropriate value, for example a value determined by the date of creation of the trusted store. The security flag further comprises a counter that is incremented each time a selected event occurs.

The security flag is stored in the trusted store. The security flag is also stored in another portion of memory, such as write-once portion of a registry. A write-once portion of a registry is a portion of a registry that becomes read only after the system is booted. Thus, contents can be written into the write-once portion of the registry, but the contents of the write-once portion of the registry can not be deleted or changed. When predetermined events occur, such as the creation of a trusted store, the addition of a timer, or the addition of activation keys, for example, a security flag is created to indicate that a predetermined event has occurred. The security flag also is stored in the write-once portion of the registry. When a selected event occurs, such as activation of a license for example, the security flag from the trusted store is compared with the security flag stored in the write-once registry. If the security flags match (within tolerance), it is determined that the trusted store has not been subjected to tampering. If the security flags do not match, or if there are not two security flags to compare, it is determined that the trusted store has been subjected to tampering.

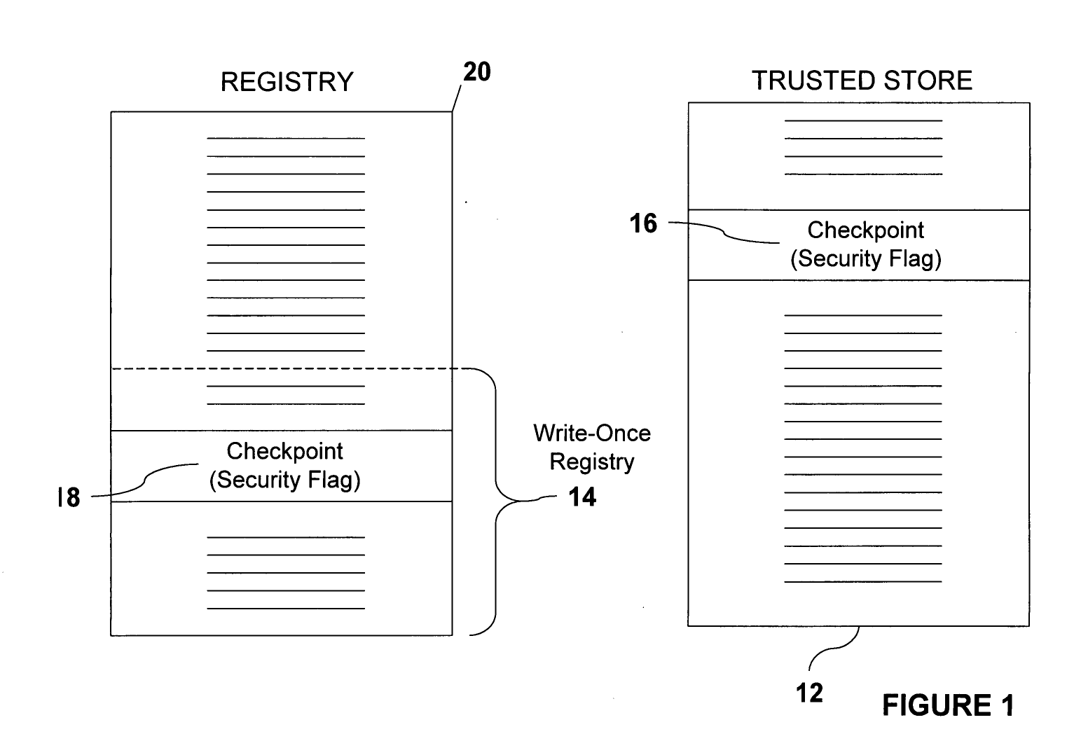

FIG. 1 is an exemplary diagram of a trusted store 12 and a registry 20 comprising security flag 16 and security flag 18, respectively. The trusted store 12 can comprise any appropriate storage means, such as semiconductor memory, magnetic memory, optical memory, hard disk memory, floppy disk memory, a database, or a combination thereof, for example. The trusted store 12 is used to store information that is to be protected. The contents of the trusted store 12 can be encrypted. The location of the trusted store 12 can be obfuscated to prevent unauthorized access to contents of the trusted store. For example, the trusted store 12 can be distributed over various files located at various portions of memory. The registry 20 and write-once registry 14 too, can comprise any appropriate storage means, such as semiconductor memory, magnetic memory, optical memory, hard disk memory, floppy disk memory, a database, or a combination thereof, for example. Further, the registry 20 and the write-once registry 14 also can be distributed over various locations in memory.

A computing system typically comprises a registry. In an exemplary embodiment, the registry 20 contains setting and other information used by an operating system. In an exemplary embodiment, the write-once registry 14 is a portion of the registry 20. The write-once registry 14 is a portion of the registry 20 that becomes read only after the system is booted or powered up. Contents can be written into the write-once registry 14, but the contents of the write-once registry 14 can not be deleted or changed. In an exemplary embodiment, the trusted store 12, the registry 20, and the write-once registry 14 are portions of a computing system running a WINDOWS® operating system.

The security flag 16 is stored in the trusted store 12. The security flag 16 can be stored in any appropriate portion of the trusted store 12. In an exemplary embodiment, the security flag 16 is stored in a header portion of the trusted store 16. The security flag 18 is stored in the registry 20. The security flag 18 can be stored in any appropriate portion of the registry 20. In an exemplary the security flag 18 is stored in the write-once registry 14. Thus, each time the security flag 18 is written into the write-once registry 14, it can not be erased. If the trusted store 12 has not been tampered with, it is envisioned that the security flag 16 will be the same as the security flag 18. But, differences can exist between the security flag 16 and the security flag 18 for reasons other than tampering. For example, the computing system can change the format of the security flag 18 when storing it in the write-once registry 14. Or, the computing system can store the security flag 18 in a different locations and types of memory than the security flag 16. Further, it is envisioned that the security flag 16 and the security flag 18 can be stored in different systems. If the trusted store 12 has not been tampered with, the security flag 16 and the security flag 18 will be indicative of the same information.

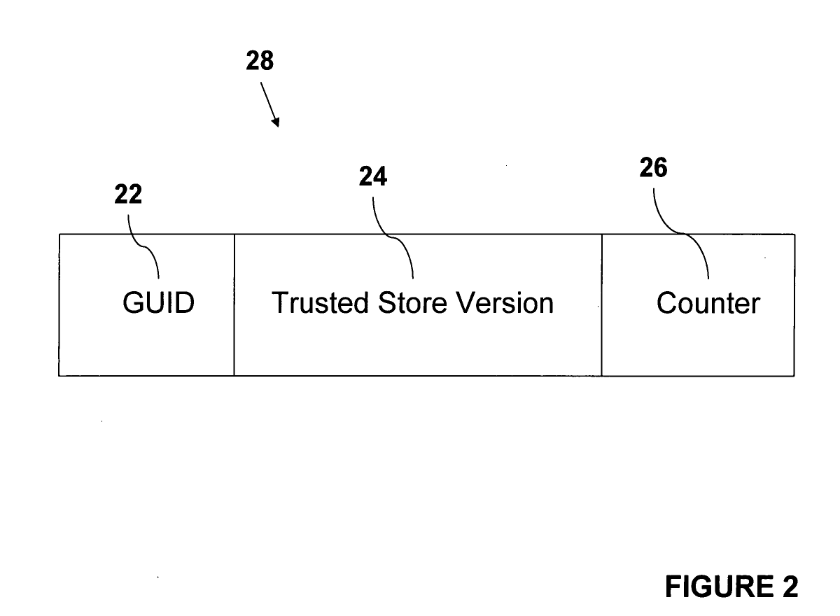

FIG. 2 is a diagram of an exemplary security flag 28. In an exemplary embodiment, the security flag 28 comprises three portions. The security flag 28 comprises a portion 22 indicative of a globally unique identifier (GUID), a portion 24 indicative of the version of the trusted store, and a portion 26 indicative of a counter. The GUID is essentially a unique identifier that identifies the system in which the security flag 28 is being used. In an exemplary embodiment, the GUID is a pseudo-random value created, in part, by using a machine identifier (an unique indicator of a specific machine or computer). Thus, the GUID is a value that is essentially unique to the system in which the security flag 28 is being utilized. In an exemplary embodiment, a new GUID is created each time a security flag is created.

The version of the trusted store is a value indicative of the current version of the trusted store in which the security flag is stored. The version of the trusted store is created, in part, by using the date and time when the trusted store is loaded into memory. The version is created when the trusted store files are created as part of building an operating system. Each release of the trusted store will result in the version number being incremented. Each time an operating system is updated, the version of the trusted store is incremented.

In an exemplary embodiment, the counter is incremented when critical events occur, such as the creation of a new security flag. For example a new security flag is created when a new timer (e.g., a WINDOWS® timer) is added, when a new timer is created, when an activation key is added, or when the system is recovering from an in-tolerance discrepancy. The entire flag is update each time a update event occurs.

When a security flag is created it is stored in the trusted store and in the write-once registry. If the trusted store is tampered with, such as replacing files in the trusted stores with older versions of the files, the tampered with version of the trusted store will not contain the security flag. Or, the tampered with version of the trusted store will contain a different security flag, or an older security flag. In either case, a comparison of the security flag stored in the trusted store with the security flag stored in the write-once registry will indicate that tampering has occurred.

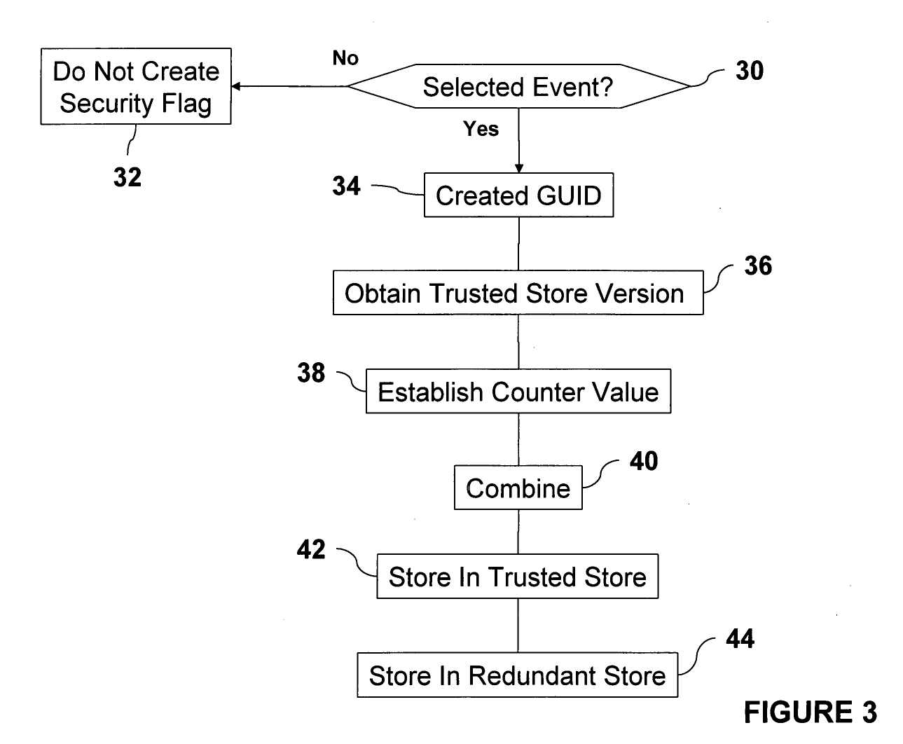

FIG. 3 is a flow diagram of an exemplary process for creating a security flag. At step 30 it is determined if a selected event has occurred, or is occurring. Examples of selected events can include addition of a timer and addition of a validation key. If it is determined (step 30) that a selected event has not occurred, or is not occurring, a security flag is not created (step 32). If it is determined (step 30) that a selected event has occurred or is occurring, a GUID is created at step 34. A GUID can be created in accordance with the above description. The version of the trusted store is obtained at step 36 and the counter value is established at step 38. The GUID, the trusted store version, and the counter are combined to form a security flag at step 40. The GUID, the trusted store version, and the counter can be combined in any appropriate manner. For example, the GUID, the trusted store version, and the counter can be concatenated to form the security flag. The security flag is stored in the trusted store at step 42. In an exemplary embodiment, the security flag is encrypted prior to being stored in the trusted store. And it is the encrypted version of the security flag that is stored in the trusted store. The security flag is stored in the write-once registry at step 44. As indicated at step 44, the security flag can be stored in any appropriate redundant store. The security flag can be stored in the redundant store in encrypted form or in the clear (unencrypted form). Once the security flags are stored in the trusted store and the redundant store, they are available to be used to determine if tampering has occurred.

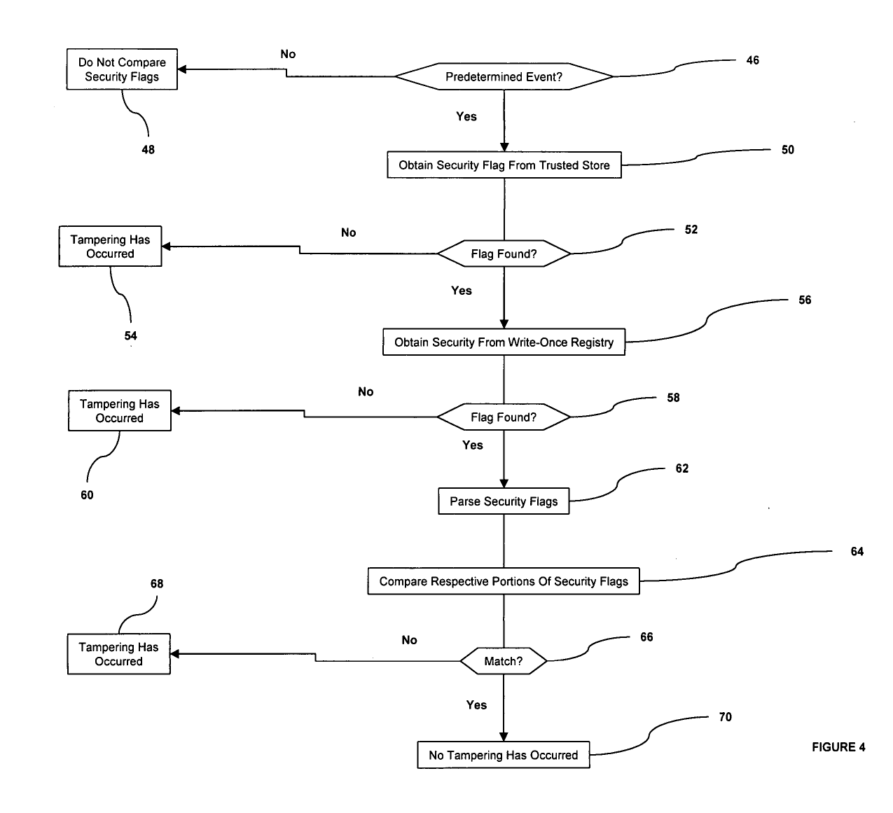

FIG. 4 is a flow diagram of an exemplary process for determining if a trusted store has been subjected to tampering. It is determined if a predetermined event has occurred or is occurring at step 30. A predetermined event can include loading a trusted store upon boot up or power up, for example. If it is determined (step 30) that a predetermined event has not occurred or is not occurring, security flags are not compared (Step 48). If it is determined (step 46) that a predetermined event has occurred or is occurring, the security flag is obtained from the trusted store at step 50. If no security flag is found in the trusted store (step 52), it is determined, at step 54, that tampering has occurred.

If a security flag is found in the trusted store (step 52), the security flag from the write-once registry is obtained at step 56. If no security flag is found in the write-once registry (step 58), it is determined, at step 60, that tampering has occurred. If a security flag is found in the write-once registry (step 58), the security flags obtained from the trusted store (step 50) and from the write-once registry (56) are parsed at step 62. The respective portions of each security flag are compared at step 64. If either of the security flags was encrypted, the encrypted security flag(s) is decrypted prior to comparison. If any of the respective portions do not match (step 66), it is determined at step 68 that tampering has occurred. If the respective portions of the security flags match (step 66), it is determined at step 70 that no tampering has occurred. Respective portions match if they each are indicative of the same information.

In an exemplary embodiment, when the respective portions of the security flags indicative of counters are compared, some tolerance is accepted. For example, if a failure, such as a system crash or power failure, occurs during the process of writing the security flag to the write-once registry, the next time the security flags from the trusted store and the write-once registry are compared, the counter values will be one increment different. To compensate for this type of failure, in an exemplary embodiment, if the value of the counter in the trusted store is one increment greater than the value of the counter in the write-once registry, it is considered a match. For example, if the counter value in the trusted store is equal to N and the counter value in the write-once registry is equal to N−1, it is considered a match, and it is determined that no tampering has occurred.

The means described herein for determining if the trusted store (or the write-once registry) has been subjected to tampering is applicable to various scenarios. For example tampering in the form of replacing files in the trusted store with alternate files can be detected. Deletion of the trusted store or files within the trusted store can be detected. Loading a trusted store in a different machine can be detected via the GUID. Further, the means is tolerant to limited clock skew. This means also prevents replay attacks. When an application creates a timer, a security flag is created. If someone tries to replay the trusted store in order to delete the timer, a security flag mismatch will occur, indicating that tampering has occurred.

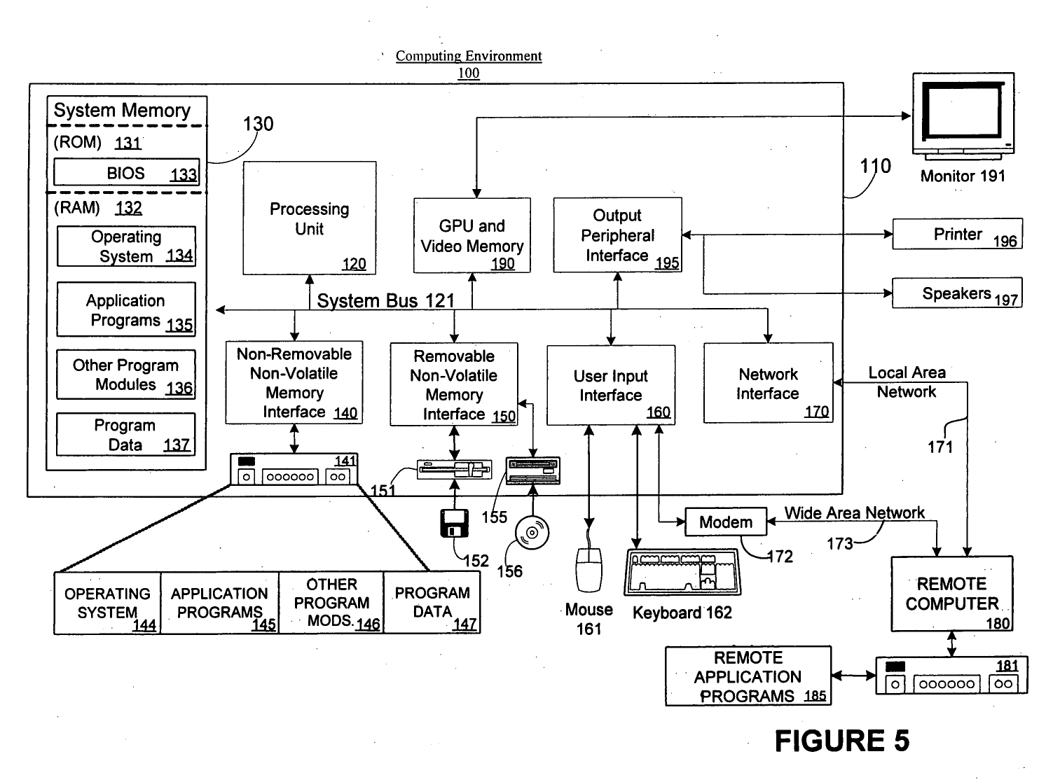

While exemplary embodiments of means for determining if a trusted store has been subjected to tampering have been described in connection with various computing devices, the underlying concepts can be applied to any computing device or system capable of determining if a trusted store has been subjected to tampering. FIG. 5 illustrates an example of a suitable computing system environment 100 on which means for determining if a trusted store has been subjected to tampering can be implemented. The computing system environment 100 is only one example of a suitable computing environment and is not intended to suggest any limitation as to the scope of use or functionality of means for determining if a trusted store has been subject to tampering. Neither should the computing environment 100 be interpreted as having any dependency or requirement relating to any one or combination of components illustrated in the exemplary operating environment 100. Although one embodiment of means for determining if a trusted store has been subjected to tampering can include components illustrated in the exemplary operating environment 100, another more typical embodiments of means for determining if a trusted store has been subjected to tampering excludes non-essential components.

With reference to FIG. 5, an exemplary system for implementing means for determining if a trusted store has been subjected to tampering includes a general purpose computing device in the form of a computer 110. Components of the computer 110 may include, but are not limited to, a processing unit 120, a system memory 130, and a system bus 121 that couples various system components including the system memory to the processing unit 120. The system bus 121 may be any of several types of bus structures including a memory bus or memory controller, a peripheral bus, and a local bus using any of a variety of bus architectures. By way of example, and not limitation, such architectures include Industry Standard Architecture (ISA) bus, Micro Channel Architecture (MCA) bus, Enhanced ISA (EISA) bus, Video Electronics Standards Association (VESA) local bus, and Peripheral Component Interconnect (PCI) bus also known as Mezzanine bus. Additionally, components of the computer 110 may include a memory cache 122. The processing unit 120 may access data from the memory cache more quickly than from the system memory 130. The memory cache 122 typically stores the data most recently accessed from the system memory 130 or most recently processed by the processing unit 120. The processing unit 120, prior to retrieving data from the system memory 130, may check if that data is currently stored in the memory cache 122. If so, a “cache hit” results and the data is retrieved from the memory cache 122 rather than from the generally slower system memory 130.

The computer 110 typically includes a variety of computer readable media. Computer readable media can be any available media that can be accessed by the computer 110 and includes both volatile and nonvolatile media, and removable and non-removable media. By way of example, and not limitation, computer readable media may comprise computer storage media and communication media. Computer storage media includes volatile and nonvolatile, removable and non-removable media implemented in any method or technology for storage of information such as computer readable instructions, data structures, program modules or other data. Computer storage media includes, but is not limited to, RAM, ROM, EEPROM, flash memory or other memory technology, CD-ROM, digital versatile disks (DVD) or other optical disk storage, magnetic cassettes, magnetic tape, magnetic disk storage or other magnetic storage devices, or any other medium which can be used to store the desired information and which can be accessed by the computer 110. Communication media typically embodies computer readable instructions, data structures, program modules or other data in a modulated data signal such as a carrier wave or other transport mechanism and includes any information delivery media. The term “modulated data signal” means a signal that has one or more of its characteristics set or changed in such a manner as to encode information in the signal. By way of example, and not limitation, communication media includes wired media such as a wired network or direct-wired connection, and wireless media such as acoustic, RF, infrared and other wireless media. Combinations of the any of the above should also be included within the scope of computer readable media.

The system memory 130 includes computer storage media in the form of volatile and/or nonvolatile memory such as read only memory (ROM) 131 and random access memory (RAM) 132. A basic input/output system 133 (BIOS), containing the basic routines that help to transfer information between elements within computer 110, such as during start-up, is typically stored in ROM 131. RAM 132 typically contains data and/or program modules that are immediately accessible to and/or presently being operated on by processing unit 120. By way of example, and not limitation, FIG. 5 illustrates operating system 134, application programs 135, other program modules 136 and program data 137.

The computer 110 may also include other removable/non-removable, volatile/nonvolatile computer storage media. By way of example only, FIG. 5 illustrates a hard disk drive 141 that reads from or writes to non-removable, nonvolatile magnetic media, a magnetic disk drive 151 that reads from or writes to a removable, nonvolatile magnetic disk 152, and an optical disk drive 155 that reads from or writes to a removable, nonvolatile optical disk 156 such as a CD ROM or other optical media. Other removable/non-removable, volatile/nonvolatile computer storage media that can be used in the exemplary operating environment include, but are not limited to, magnetic tape cassettes, flash memory cards, digital versatile disks, digital video tape, solid state RAM, solid state ROM, and the like. The hard disk drive 141 is typically connected to the system bus 121 through a non-removable memory interface such as interface 140, and magnetic disk drive 151 and optical disk drive 155 are typically connected to the system bus 121 by a removable memory interface, such as interface 150.

The drives and their associated computer storage media, discussed above and illustrated in FIG. 5, provide storage of computer readable instructions, data structures, program modules and other data for the computer 110. In FIG. 5, for example, hard disk drive 141 is illustrated as storing operating system 144, application programs 145, other program modules 146 and program data 147. Note that these components can either be the same as or different from operating system 134, application programs 135, other program modules 136, and program data 137. Operating system 144, application programs 145, other program modules 146, and program data 147 are given different numbers hereto illustrate that, at a minimum, they are different copies. A user may enter commands and information into the computer 110 through input devices such as a tablet, or electronic digitizer, a microphone, a keyboard 162, and pointing device 161, commonly referred to as a mouse, trackball or touch pad. Other input devices (not shown) may include a joystick, game pad, satellite dish, scanner, or the like. These and other input devices are often connected to the processing unit 120 through a user input interface 160 that is coupled to the system bus, but can be connected by other interface and bus structures, such as a parallel port, game port or a universal serial bus (USB). A monitor 191 or other type of display device is also connected to the system bus 121 via an interface, such as a video interface 190. The monitor 191 may also be integrated with a touch-screen panel or the like. Note that the monitor and/or touch screen panel can be physically coupled to a housing in which the computing device 110 is incorporated, such as in a tablet-type personal computer. In addition, computers such as the computing device 110 may also include other peripheral output devices such as speakers 197 and printer 196, which may be connected through an output peripheral interface 194 or the like.

The computer 110 may operate in a networked environment using logical connections to one or more remote computers, such as a remote computer 180. The remote computer 180 may be a personal computer, a server, a router, a network PC, a peer device or other common network node, and typically includes many or all of the elements described above relative to the computer 110, although only a memory storage device 181 has been illustrated in FIG. 5. The logical connections depicted in FIG. 5 include a local area network (LAN) 171 and a wide area network (WAN) 173, but may also include other networks. Such networking environments are commonplace in offices, enterprise-wide computer networks, intranets and the Internet. For example, in accordance with means for determining if a trusted store has been subjected to tampering, the computer 110 can comprise the source machine from which data is being migrated, and the remote computer 180 may comprise the destination machine. Note however that source and destination machines need not be connected by a network or any other means, but instead, data may be migrated via any media capable of being written by the source platform and read by the destination platform or platforms.

When used in a LAN networking environment, the computer 110 is connected to the LAN 171 through a network interface or adapter 170. When used in a WAN networking environment, the computer 110 typically includes a modem 172 or other means for establishing communications over the WAN 173, such as the Internet. The modem 172, which may be internal or external, may be connected to the system bus 121 via the user input interface 160 or other appropriate mechanism. In a networked environment, program modules depicted relative to the computer 110, or portions thereof, may be stored in the remote memory storage device. By way of example, and not limitation, FIG. 5 illustrates remote application programs 185 as residing on memory device 181. It will be appreciated that the network connections shown are exemplary and other means of establishing a communications link between the computers may be used.

The various techniques described herein can be implemented in connection with hardware or software or, where appropriate, with a combination of both. Thus, the methods and apparatus for determining if a trusted store has been subjected to tampering, or certain aspects or portions thereof, can take the form of program code (i.e., instructions) embodied in tangible media, such as floppy diskettes, CD-ROMs, hard drives, or any other machine-readable storage medium, wherein, when the program code is loaded into and executed by a machine, such as a computer, the machine becomes an apparatus for determining if a trusted store has been subjected to tampering. In the case of program code execution on programmable computers, the computing device will generally include a processor, a storage medium readable by the processor (including volatile and non-volatile memory and/or storage elements), at least one input device, and at least one output device. The program(s) can be implemented in assembly or machine language, if desired. In any case, the language can be a compiled or interpreted language, and combined with hardware implementations.

The methods and apparatus for determining if a trusted store has been subjected to tampering also can be practiced via communications embodied in the form of program code that is transmitted over some transmission medium, such as over electrical wiring or cabling, through fiber optics, or via any other form of transmission, wherein, when the program code is received and loaded into and executed by a machine, such as an EPROM, a gate array, a programmable logic device (PLD), a client computer, or the like, the machine becomes an apparatus for practicing a method for determining if a trusted store has been subjected to tampering. When implemented on a general-purpose processor, the program code combines with the processor to provide a unique apparatus that operates to invoke the functionality of means for determining if a trusted store has been subjected to tampering. Additionally, any storage techniques used in connection with means for determining if a trusted store has been subjected to tampering can invariably be a combination of hardware and software.

Means for determining if a trusted store has been subjected to tampering typically includes at least some form of computer readable media. Computer readable media can be any available media that can be accessed by means for determining if a trusted store has been subjected to tampering. By way of example, and not limitation, computer readable media may comprise computer storage media and communication media. Computer storage media includes volatile and nonvolatile, removable and non-removable media implemented in any method or technology for storage of information such as computer readable instructions, data structures, program modules or other data. Computer storage media includes, but is not limited to, RAM, ROM, EEPROM, flash memory or other memory technology, CD-ROM, digital versatile disks (DVD) or other optical storage, magnetic cassettes, magnetic tape, magnetic disk storage or other magnetic storage devices, or any other medium which can be used to store the desired information and which can accessed by means for determining if a trusted store has been subjected to tampering. Communication media typically embodies computer readable instructions, data structures, program modules or other data in a modulated data signal such as a carrier wave or other transport mechanism and includes any information delivery media. The term “modulated data signal” means a signal that has one or more of its characteristics set or changed in such a manner as to encode information in the signal. By way of example, and not limitation, communication media includes wired media such as a wired network or direct-wired connection, and wireless media such as acoustic, RF, infrared and other wireless media. Combinations of the any of the above should also be included within the scope of computer readable media.

While means for determining if a trusted store has been subjected to tampering have been described in connection with the exemplary embodiments of the various figures, it is to be understood that other similar embodiments can be used or modifications and additions can be made to the described embodiments for performing the same functions of means for determining if a trusted store has been subjected to tampering without deviating therefrom. Therefore, means for determining if a trusted store has been subjected to tampering as described herein should not be limited to any single embodiment, but rather should be construed in breadth and scope in accordance with the appended claims.

What is claimed:

1. A method for determining if memory has been subjected to tampering, said method comprising:
storing a security flag in a first memory, said security flag being indicative of:
a creation of said security flag; and
a version of said first memory;
storing said security flag in a second memory;
upon an occurrence of a predetermined event, comparing said security flag stored in said first memory with said security flag stored in said second memory; and
in accordance with a result of said comparison, determining if said first memory has been subjected to tampering.

2. A method in accordance with claim 1, wherein said security flag comprises:
a first portion indicative of an identifier assigned to said security flag upon creation of said security flag;
a second portion indicative of a version of said first memory; and
a third portion indicative of a counter.

3. A method in accordance with claim 2, further comprising:
upon an occurrence of a selected event, modifying said security flag;
storing said modified security flag in said first memory; and
storing said modified security flag in said second memory.

4. A method in accordance with claim 3, wherein said act of modifying comprises incrementing said counter.

5. A method in accordance with claim 1, further comprising:
determining that said first memory has not been subjected to tampering if said security flag stored in said first memory is approximately identical to said security flag stored in said second memory;
determining that said first memory has not been subjected to tampering if a value of a counter of said security flag stored in said second memory is equal to a value of a counter of said security flag stored in said first memory minus one;
determining that said first memory has been subjected to tampering if said security flag is stored in said first memory and said security flag is not stored in said second memory; and
determining that said first memory has been subjected to tampering if said security flag is stored in said second memory and said security flag is not stored in first second memory.

6. A method in accordance with claim 5, further comprising:
if a value of a counter of said security flag stored in said second memory is equal to a value of a counter of said security flag stored in said first memory minus one, storing in said second memory, said security flag in said first memory.

7. A method in accordance with claim 1, wherein:
said first memory comprises a trusted store; and
contents stored in said second memory are unerasable.

8. A method in accordance with claim 1, wherein said second memory comprises a write-once registry.

9. A method in accordance with claim 1, wherein said act of comparing comprises comparing said security flag stored in said first memory with a most recently stored security flag in said second memory.

10. A computer-readable medium having computer-executable instructions for performing the acts of:
storing a security flag in a first memory, said security flag comprising:
a first portion indicative of an identifier assigned to said security flag upon creation of said security flag;
a second portion indicative of a version of said first memory; and
a third portion indicative of a counter;
storing said security flag in a second memory;
upon an occurrence of a predetermined event, comparing said security flag stored in said first memory with said security flag stored in said second memory; and
in accordance with a result of said comparison, determining if said first memory has been subjected to tampering.

11. A computer-readable medium in accordance with claim 10, said computer-readable medium having further computer-executable instructions for:
upon an occurrence of a selected event, incrementing said counter of said security flag;
storing said modified security flag in said first memory; and
storing said modified security flag in said second memory.

12. A computer-readable medium in accordance with claim 10, said computer-readable medium having further computer-executable instructions for:
determining that said first memory has not been subjected to tampering if said security flag stored in said first memory is approximately identical to said security flag stored in said second memory;
determining that said first memory has not been subjected to tampering if a value of a counter of said security flag stored in said second memory is equal to a value of a counter of said security flag stored in said first memory minus one;
determining that said first memory has been subjected to tampering if said security flag is stored in said first memory and said security flag is not stored in said second memory; and
determining that said first memory has been subjected to tampering if said security flag is stored in said second memory and said security flag is not stored in first second memory.

13. A computer-readable medium in accordance with claim 10, wherein said act of comparing comprises comparing said security flag stored in said first memory with a most recently stored security flag in said second memory.

14. A system for determining if memory has been subjected to tampering, said system comprising:
a first memory comprising a security flag, said security flag being indicative of:
a creation of said security flag; and
a version of said first memory;
a second memory, wherein:
upon an occurrence of a predetermined event, comparing said security flag stored in said first memory with said security flag stored in said second memory; and
in accordance with a result of said comparison, determining if said first memory has been subjected to tampering.

15. A system in accordance with claim 14, wherein, upon an occurrence of a selected event, said security flag is modified and said modified security flag is stored in said first memory and said second memory.

16. A system in accordance with claim 14, wherein said security flag comprises:
a first portion indicative of an identifier assigned to said security flag upon creation of said security flag;
a second portion indicative of a version of said first memory; and
a third portion indicative of a counter.

17. A system in accordance with claim 14, wherein said first memory comprises a trusted store and contents stored in said second memory are unerasable.

18. A system in accordance with claim 14, wherein:
said first memory comprises a trusted store; and
contents stored in said second memory comprises a read only registry.

19. A system in accordance with claim 14, wherein:
said first memory is determined to not have been subjected to tampering if said security flag stored in said first memory is approximately identical to said security flag stored in said second memory;
said first memory is determined to not have been subjected to tampering if a value of a counter of said security flag stored in said second memory is equal to a value of a counter of said security flag stored in said first memory minus one;
said first memory is determined to have been subjected to tampering if said security flag is stored in said first memory and said security flag is not stored in said second memory; and
said first memory is determined to have been subjected to tampering if said security flag is stored in said second memory and said security flag is not stored in first second memory.

20. A system in accordance with claim 19, wherein:
if a value of a counter of said security flag stored in said second memory is equal to a value of a counter of said security flag stored in said first memory minus one, said security flag of said first memory is stored in said second memory.
